(19) United States
(12) Patent Application Publication
(10) Pub. No.: US 2014/0212288 A1
(43) Pub. Date: Jul. 31, 2014

(54) HIGH CAPACITY ELEVATOR FOR WIND TURBINE MAINTENANCE

(71) Applicant: CONDOR WIND ENERGY LIMITED, London (GB)

(72) Inventors: Martin Jakubowski, London (GB); Silvestro Caruso, London (GB); Luciano Caioli, London (GB)

(73) Assignee: CONDOR WIND ENERGY LIMITED, London (GB)

(21) Appl. No.: 14/119,709

(22) PCT Filed: May 24, 2012
(86) PCT No.: PCT/IB2012/001118

§ 371 Date: Apr. 9, 2014

Related U.S. Application Data
(60) Provisional application No. 61/489,368, filed on May 24, 2011.

(51) Int. Cl. F03D 11/04

(52) U.S. Cl. CPC F03D 11/04
USPC 416/144

(57) ABSTRACT

The invention generally relates elevator assemblies suitable for lifting heavy components associated with wind turbines. In certain embodiments, the invention provides an elevator assembly encompassing a wind turbine nacelle and an elevator frame. The elevator frame is configured to surround a tower supporting the nacelle of the wind turbine and is equipped with a means for balancing the frame along a horizontal axis. In some aspects, the means for balancing the frame include a ballast tank system.

### REFERENCE TO RELATED APPLICATIONS

This application claims priority to U.S. Provisional Application No. 61/489,368, filed May 24, 2011, the content of which is herein incorporated by reference in its entirety.

### FIELD OF THE INVENTION

The invention generally relates to offshore wind turbines and associated high capacity elevators.

### BACKGROUND

Wind power refers to the conversion of wind energy into more useful forms of energy, such as electricity. Wind energy is an attractive alternative to fossil fuels because it is plentiful, renewable, widely distributed, clean, and produces no greenhouse gas emissions. Wind energy currently accounts for about 1.5% of worldwide electricity usage, and approximately eighty countries around the world use wind power on a commercial basis (World Wind Energy Report 2008: Report, World Wind Energy Association, February 2009; and Worldwatch Institute: Wind Power Increase in 2008 Exceeds 10-year Average Growth Rate, May 2009). Further, world wind generation capacity has more than quadrupled between the years 2000 and 2006, doubling about every three years.

Wind turbines harness the power of powerful winds in order to generate electricity. Maintenance of these turbines can require the lifting of heavy components such as rotors or gearboxes to the height of the turbine nacelle. Conventional means of raising such components include the use of high capacity cranes, either in the form of mobile cranes for onshore use or jack-up cranes or crane vessels for offshore use. While the deployment of high capacity cranes on land poses relatively little difficulty, the harsh weather conditions associated with offshore environments can make such use problematic. In addition, strong waves native to the deep sea can adversely affect the precision needed to position a heavy component by crane to the desired point. Waiting for these inclement conditions to subside so that these cranes can be used may result in significant downtime.

Accordingly, there is a need for an improved means of moving heavy components associated with wind turbines to a desired level on the turbine that is suitable for the inclement conditions associated with offshore environments.

### SUMMARY

The invention generally relates to elevator assemblies suitable for wind turbines encompassing an elevator frame that surrounds the supporting tower of the wind turbine nacelle. The elevator assembly encompasses a frame on which the heavy components associated with turbines, including rotors, generators, and gearboxes, can be placed in order to move them up or down the tower. The frame is designed to be mounted around the base of the tower that supports the wind turbine nacelle. To this end, the frame of the elevator can be made from two or more frame components that can be assembled at the site of installation. The individual frame components are secured together by joints of sufficient strength that are also easy to connect and disconnect. The frame can be driven vertically along the tower from the base of the tower to the top, where the nacelle is situated, by strand jacks installed onto the nacelle. The strand jacks operate to drive multiple strands or cables anchored to the frame.

The invention further contemplates a means for balancing the frame along a horizontal axis. The taking and releasing of the weight of a heavy component by the elevator frame cause a variation of the centre of gravity of the elevator, with consequent moments and forces generated due to the distance between the centre of gravity and the strands lifting point. The balancing system contemplated by the invention serves to redistribute the forces along the entirety of the frame, in an amount required to balance the load attributable to the heavy component and substantially realigning the centre of gravity with the strands' lifting point. In certain aspects, the balancing system is a ballast tank system. In this system, the ballast tanks are positioned at select points on the elevator frame. To balance a load attributed to a heavy component, the ballast can be moved between the tanks of the system in order to compensate for the new weight distribution.

The invention also contemplates the use of accessory tools that can be mounted onto the elevator frame. The accessory tools can be specifically configured to accommodate and cradle heavy turbine components as the elevator frame moves the component up or down the tower. The accessory tool also allows fine positioning of the various components during their incorporation or removal into the nacelle. For example, the accessory tool can be configured so that when the elevator frame is at maximum height, a cradled turbine rotor is positioned at the appropriate point on a nacelle. To further achieve the fine positioning of a cradled component, the accessory tool can be designed to move or slide horizontally, in two directions. The accessory tool can also be designed to tilt in an upwards direction to adjust the position of the cradled objects.

It has been found that high capacity elevator frames configured to surround the tower of the turbine offer certain benefits over the crane vessels or jack-up cranes typically used to install heavy components. The elevator frame contemplated by the invention can be installed using a small mobile crane or supply vessel in offshore applications. Unlike jack-up cranes or crane vessels, small mobile cranes and normal supply vessels are readily available at short notice, with low mobilization costs. In addition, the use of small mobile cranes or normal supply vessels is intrinsically cheaper and easier to contract when compared to heavy mobile cranes or large floating jack-up cranes. Accordingly, the invention enables the maintenance, installation, and decommissioning of a wind turbine without the employment of heavy crane equipment.

As contemplated by the invention, the elevator can be installed using a small mobile crane or standard supply vessel around the bottom section of the tower and can be operated by strand jacks or other heavy lifting devices. The movement of the elevator is guided by the turbine tower, through wheels or runners installed on the elevator frame that run along tracks built into the tower.

In certain embodiments of the invention, an assembly is provided. The assembly includes a wind turbine nacelle and a frame. The frame is operably configured to surround a tower supporting the wind turbine nacelle. The assembly also includes a means for balancing the frame along a horizontal axis. In certain aspects, the frame encompasses at least two frame components that when joined together, constitute the frame. The assembly can also include supports installed into the tower that are configured to support a frame component. Means for balancing the frame contemplated by the invention includes a ballast tank system. In more specific aspects, the ballast tank system is a liquid ballast tank system. The ballast tank system can comprise at least two ballast tanks. In certain aspects, one of the ballast tanks can be positioned at the front of the frame while the other ballast tank is positioned at the rear. The invention also contemplates lifting devices used to move the frame along the tower. The lifting devices can be mounted onto the turbine nacelle. In certain aspects, a cable is at one end connected to the frame and the lifting device is in contact with the cable at another point, so that movement of the frame is achieved by the lifting device acting on the cable. In some aspects, a strand is used instead of a cable. In certain aspects, assemblies contemplated by the invention include an accessory tool configured for mounting onto the frame. The accessory tools can be further configured to accommodate various wind turbine components, including but not limited to wind turbine rotors. In addition, the accessory tool can be configured to move in a horizontal direction relative to the front of the nacelle. The accessory tool can also be configured to tilt in an upwards direction. In addition to these embodiments, additional aspects of the invention will become evident upon reading the present disclosure.

### BRIEF DESCRIPTION OF THE DRAWINGS

FIG. 1 depicts a detailed schematic of the invention, according to certain embodiments.

FIG. 2 depicts an embodiment of the invention, from an angled perspective.

FIG. 3 depicts a magnified view of an elevator assembly, according to certain embodiments, positioned near the nacelle of a wind turbine.

FIG. 4 depicts another magnified view of the elevator assembly, according to certain embodiments.

FIG. 5 depicts yet another view of the elevator assembly, according to certain embodiments.

### DETAILED DESCRIPTION

The invention provides an elevator assembly encompassing a wind turbine nacelle and a frame. The frame is operably configured to surround a tower supporting the wind turbine nacelle. The assembly also includes a means for balancing the frame along a horizontal axis. In contrast to conventional methods of moving heavy turbine components at sea, such as crane vessels, the contemplated assembly provides a means for raising heavy components that is less affected by the harsh climates found offshore. In addition, the contemplated assembly allows more precise positioning of a heavy component relative to its intended position on the nacelle.

Wind turbines and their construction are already known in the art. The invention contemplates a frame that is designed to operate around the tower that supports the wind turbine nacelle. In other words, the frame structure surrounds the wind turbine tower. In certain embodiments of the invention, the tower has a cylindrical shape. As such, the area of the tower is circular. In other embodiments, the area of the tower can encompass other shapes including, but not limited to, squares and other polygons.

The frame itself can be made from any material known in the art suitable for hoisting heavy loads and withstanding the rigors associated with deep sea environments. In some embodiments, the frame is made out of steel. In other embodiments, the frame can be made from aluminum if a lighter weight is desired or from a composite material.

The invention also includes a means for balancing the frame along a horizontal axis. As contemplated by the invention, the elevator frame can move more efficiently up and down the turbine tower if its center of gravity corresponds to the position of the strands or cables that raise or lower the frame along the tower. In this manner, the elevator frame is horizontally aligned and does not introduce stress to the tower. To this end, certain embodiments of the invention encompass two ballast tanks that can be positioned asymmetrically with respect to the cables, one tank at each side of the frame. A bi-directional pump controlled by a Programmable Logic Controller (PLC) system can automatically move a liquid ballast, for example, from one tank to the other, in order to balance the weight based on signals received by the PLC. The PLC can receive signals from, for example, the load itself or through installed inclination sensors. When the elevator is empty, the ballast is contained in the tank closer to the cables, on the same end where a heavy component would be accommodated. When the elevator frame is actually accommodating a load, the ballast is moved to the tank at the other end of the frame, in an amount required to offset the increased load. This introduces the desired balance to the frame prior to moving the frame to lower or lift the load.

The invention also includes lifting devices or jacks that can drive movement of the elevator frame up and down the tower of the wind turbine by acting on the strands or cables connected to the frame. As contemplated by the invention, the lifting jacks and strands are of limited weight and size and can be easily lifted for installation in the nacelle by a maintenance hoist incorporated into the turbine assembly. Alternatively, the jacks and strands can be dropped onto the roof of the nacelle by helicopter. The lifting drives or devices can be mounted directly on the elevator frame, acting on the tower or on racks fitted to it, however, one embodiment provides that the strand jacks are installed in the nacelle at specific anchor points. As contemplated by the invention, installing the strand jacks at specific anchor points makes access to the jacks relatively easy should the need arise. In certain embodiments, the anchor points encompass hydraulic cylinders equipped with grip devices for taking multiple cables or strands anchored to the frame. Once the jacks have been fixed to their corresponding anchor points on the nacelle and connected to a power supply system, for example, a hydraulic supply system, the openings provided through the cover below and over the cylinders are opened. After the hydraulic strand gripping edges provided at each end of the jacks are hydraulically opened to leave a free passage, each strand is driven through the roof opening down to the jack. The strand is then driven through its associated wedge system and then down to an anchor block mounted on the frame. A strand gripping wedge in the anchor block receives and secures the end of the strand. The operation is repeated until all the strands are secured. The wedges of the jacks are released, the strands are pulled to have the desired level of tautness, and the assembly is ready for operation.

In additional aspects, assemblies encompasses by the invention include accessory tools that are mounted onto the frame. The accessory tool can be made from the same materials as the frame, for example, steel, aluminum, or some composite material. Any material can be used to construct the accessory tool provided it is suitable for hoisting heavy loads and can withstand the rigors associated with the deep sea. The assembly tool can be configured to accommodate or cradle the heavy components associated with wind turbine operation. For example, the accessory tool can be configured to accommodate a wind turbine rotor, a generator, or a gearbox. Furthermore, the accessory tool can be configured to facilitate the precise positioning of the component relative to a desired location on the nacelle. In some embodiments, the accessory tool can slide horizontally relative to the front of the nacelle. In other words, the accessory tool can move sideways to the left or to the right. In addition, the accessory tool can be designed to tilt in an upwards direction. The capacity of the accessory tool to slide horizontally and tilt upwards is provided respectively by linear guides and hinged connections located between the accessory tool and the elevator frame.

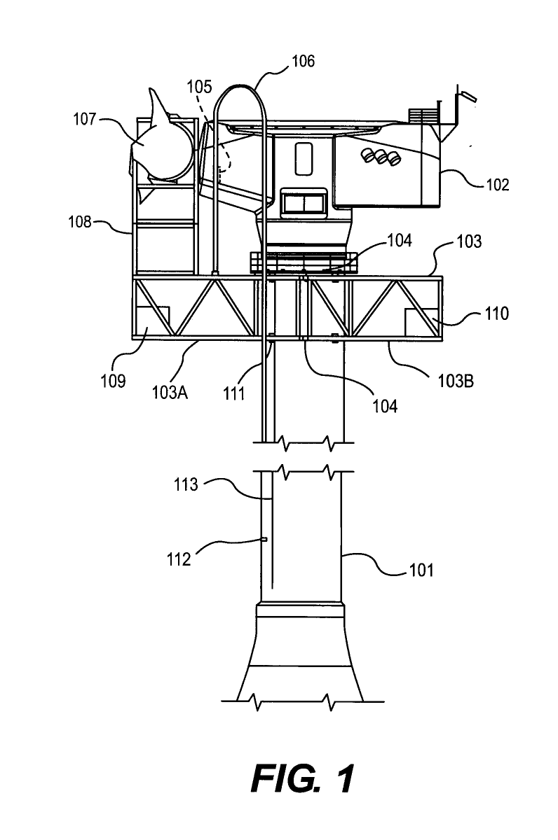

One assembly in accordance with the invention is presented in FIG. 1. In FIG. 1, the elevator frame 103 is mounted around the tower 101 of a wind turbine nacelle 102 at a maximum height. At this maximum height, the elevator frame 103 is close to the nacelle 102 and in position to install a two bladed turbine rotor 107 onto the nacelle 102. In the embodiment shown, the elevator frame 103 comprises two components, 103a and 103b. The two component assembly allows the elevator frame 103 to be assembled at the base of the tower 101. The tower 101 is equipped with supports 112 that can prop the elevator frame components 103a and 103b during assembly.

As further depicted in FIG. 1, wheels 111 are fitted at the top and bottom of the elevator frame 103 to facilitate vertical motion of the frame 103 along the tower 101. In certain embodiments of the invention, rollers or runners can be used as well. The number, size, and type of the wheels, rollers or runners can be modified as desired and selected based on mitigating potential damage to the tower surface. Proper guides 113 or tracks for the wheels 111 can be installed along the tower 101 surface to prevent rotation of the frame 103 around the tower 101 and scoring of the tower 101 surface by the wheels 111. Cables 106 connected to the frame component 103a move the elevator frame 103 in a vertical direction along the tower, however, the addition of ballast tanks 109 and 110 on either side of the frame 103 serve to balance the frame 103 as it is accommodating a heavy load. In the embodiment shown, two ballast tanks 109 and 110 are provided, however, the number, size, and configuration of the tanks can be changed as needed.

Lifting devices 105 are incorporated into the nacelle at specific anchor points to coordinate movement of the cables 106. The number and location of the lifting devices 105 can be modified as needed. In certain embodiments of the invention, there are two lifting devices 105, one on each side of the nacelle 102. The lifting devices 105 can operate via hydraulic or electric power with synchronization systems to coordinate horizontal alignment of the elevator frame 103. In certain embodiments, the hydraulic pressure source is provided by a power unit positioned on the nacelle roof or by the turbine hydraulic system, through a valve block commanded by a Programmable Logic Controller (PLC) system. As shown in FIG. 1, lifting devices 105 encompassed by the invention include, but are not limited to, strand jacks located onto the nacelle 102 at proper anchor points which allow the lifting and lowering of the elevator frame 103 by multiple strands passing through proper openings of the nacelle cover and bent outwards toward the elevator frame 103. Other lifting devices encompassed by the invention include, but are not limited to chain and wire rope hoists. The type of lifting device can also be modified depending on the load to be lifted. Regardless of the type, lifting devices contemplated by the invention can be driven by manual or automated means.

FIG. 1 further depicts an accessory tool 108 mounted on the elevator frame 103 which facilitates lifting a two-bladed rotor 107 to the appropriate position on the nacelle 102. Linear guides installed between the elevator frame 103 and the accessory tool 108 allows the tool 108 to slide sideways in both leftward and rightward directions. Hinged connections installed between the frame 103 and the tool 108 allow the tool 108 to be tilted in up to three directions. The degrees of movement made possible by the guides and hinges allow the fine adjustment of the cradled rotor 107 as needed for installation into the nacelle 102. The movement of the accessory tool 108 can be driven by remote controlled electro-mechanical linear actuators or hydraulic cylinders. In the embodiment provided in FIG. 1, the accessory tool 108 is designed to accommodate a two-bladed rotor 107, however, contemplated accessory tools can be configured to accommodate other heavy turbine components, such as generators, gearboxes, etc.

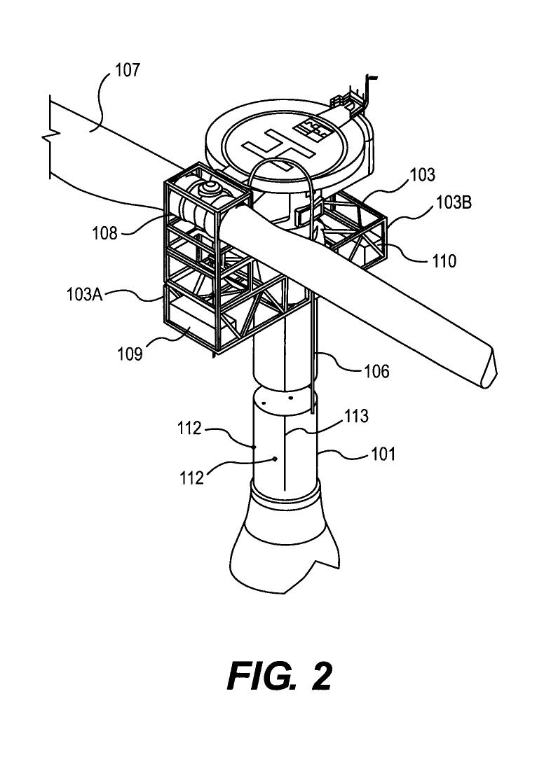

An alternate view of an embodiment of the invention is presented in FIG. 2. As shown, an elevator frame 103 is equipped with an accessory tool 108 configured to hoist a two-bladed turbine rotor 107. The accessory tool 108 is able to bring the rotor 107 directly to a desired location on the nacelle 102. Ballast tanks 109 and 110 help balance the elevator frame 103 loaded with the weight of the rotor 107.

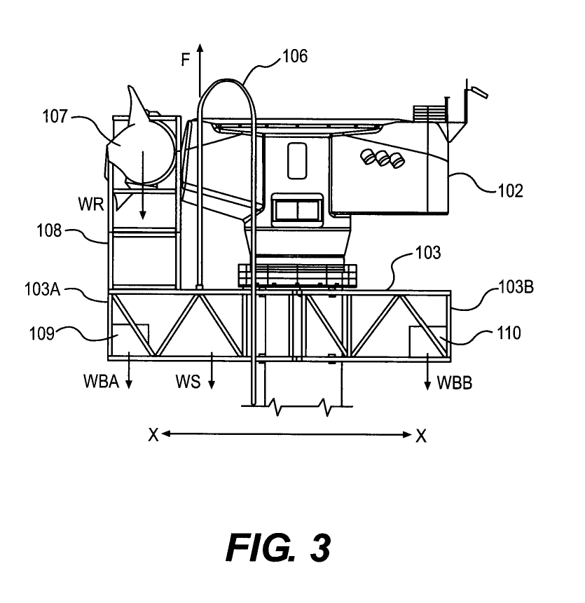

The distribution of forces in a loaded elevator frame 103 is shown in FIG. 3. The frame 103 is equipped with an accessory tool 108 hoisting a turbine rotor 107. In certain embodiments of the invention, the elevator assembly has the ability to vary its center of gravity along the axis x-x according to the load lifted. This can be achieved, for example, by two ballast tanks 109 and 110 that are provided to balance the weight of the lifted component by moving the ballast from one tank 109 to another 110. In some embodiments of the invention, the ballast tanks 109 and 110 are liquid ballast tanks. In embodiments encompassing a liquid ballast, the elevator assembly can be equipped with a PLC controlled hydraulic system, which based on signals of inclination or load sensors, moves the ballast from one tank to other to achieve the desired balancing, before moving the elevator in a vertical direction. The vertical movement is achieved by strands or cables 106 connected to the elevator frame component 103a suitably positioned so that it is possible to balance the weight of the accommodated component using the ballast tanks 109 and 110. Alternate embodiments of balancing the elevator frame 103 include masses that can be moved longitudinally along the frame 103. FIG. 3 depicts a heavy component, in this case a turbine rotor 107, accommodated by the accessory tool 108. The weight of the turbine rotor 107, represented by WR, unbalances the elevator frame 103 excessively towards the front of the nacelle 102, making lifting the rotor 107 to the desired location difficult. As contemplated by the invention, while the elevator frame 103 is taking the load WR, the ballast is moved from the front ballast tank 109 to the rear 110 in order to compensate for the increased load attributable to the rotor 107. WBA is the ballast weight remaining in the front ballast tank 109, WBB is the weight in the rear ballast tank 110, and WS is the weight of the elevator structure. The load lifted F is the sum of the weights applied. As the distance of the balancing tanks 109 and 110 from the cables 106 is larger than the distance from them to the load center of gravity, proportionately smaller ballast is sufficient to compensate the load.

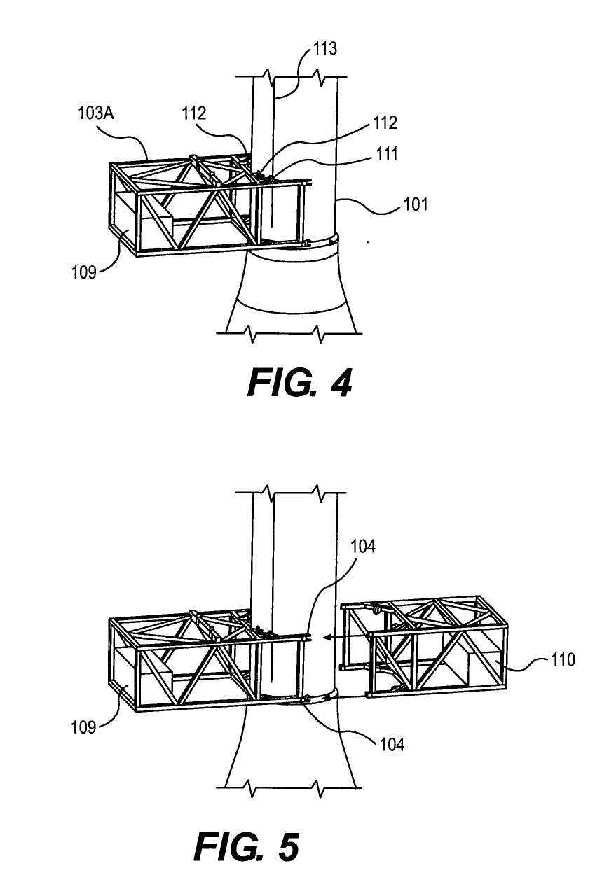

FIG. 4 and FIG. 5 depict the assembly of the elevator frame. As explained previously, the invention encompasses elevator frames prepared from two or more frame components. As shown in FIG. 4, a first frame component 103a is temporarily placed and secured on supports 112 provided at the base of the tower 101 and the wheels 111 mounted on the first frame component 103a are positioned into the track guides 113. As shown in FIG. 5, a second frame component 103b is brought in contact with the first frame component 103a and coupled to it through locking devices 104. In certain embodiments, the locking devices 104 can be actuated manually or automatically through electro-mechanically or hydraulically actuated systems. In certain embodiments, the locking devices 104 can comprise hinges jointing the two frames 103a and 103b.

The use of a high capacity elevator to lift heavy turbine components mitigates the need for cranes that function suboptimally in offshore environments. Other elements depicted in the various embodiments facilitate the convenient assembly of the elevator, further enhance the ability of the elevator to efficiently lift heavy loads, as well as allow more precise positioning of heavy turbine components.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. An assembly, the assembly comprising:
a wind turbine nacelle;
a frame, wherein the frame is operably configured to surround a tower supporting the wind turbine nacelle; and
a means for balancing the frame along a horizontal axis.

2. The assembly of claim 1, wherein the frame comprises at least two frame components that when joined together, constitute the frame.

3. The assembly of claim 2, further comprising support structures installed onto the nacelle tower, wherein the supporting members are operably configured to support a frame component.

4. The assembly of claim 1, wherein the means for balancing the frame is a ballast tank system.

5. The assembly of claim 4, wherein the ballast tank system is a liquid ballast tank system.

6. The assembly of claim 4, wherein the ballast tank system comprises at least two ballast tanks

7. The assembly of claim 6, wherein a first ballast tank is positioned at a front end of the frame and a second ballast tank is positioned at a rear end of the frame.

8. The assembly of claim 1, further comprising at least one lifting device mounted onto the turbine nacelle.

9. The assembly of claim 1, further comprising at least one cable, wherein the lifting device is in contact with the cable and wherein one end of the cable is in contact with the frame.

10. The assembly of claim 1, further comprising an accessory tool configured for mounting on the frame, wherein the accessory tool is operably configured to cradle a wind turbine component.

11. The assembly of claim 11, wherein the wind turbine component is a wind turbine rotor.

12. The assembly of claim 10, wherein the accessory tool is operably configured to move a horizontal direction relative to the front of the nacelle.

13. The assembly of claim 10, wherein the accessory is operably configured to tilt in an upwards direction.
